(19) United States
(12) Patent Application Publication
(10) Pub. No.: US 2024/0167944 A1
(43) Pub. Date: May 23, 2024

(54) Multi-Order Spectroscopy

(71) Applicant: OneLight Sensing, LLC, San Jose, CA (US)

(72) Inventor: Michael G. Solonenko, San Diego, CA (US)

(21) Appl. No.: 18/509,614

(22) Filed: Nov. 15, 2023

Related U.S. Application Data
(60) Provisional application No. 63/426,310, filed on Nov. 17, 2022.

(51) Int. Cl. G01N 21/31

(52) U.S. Cl. CPC G01N 21/31; G01N 2201/0635

(57) ABSTRACT

A system may include a diffraction grating, an optical detector, and multiple optical systems (e.g., at least two). The optical detector includes a detection surface configured to detect optical signals. The optical detector is positioned so the detection surface receives diffracted spectra from the diffraction grating. A first optical beam forming system directs a first optical beam towards the diffraction grating such that a diffracted spectrum of the first optical beam is received by a first portion of the detection surface of the optical detector. A second optical beam forming system (different that the first optical beam forming system) directs a second optical beam towards the diffraction grating such that a diffracted spectrum of the second optical beam is received by a second portion of the detection surface of the optical detector (e.g., different than the first portion of the detection surface).

### CROSS-REFERENCE TO RELATED APPLICATION

This application claims the benefit of and priority to U.S. Provisional Patent Application Ser. No. 63/426,310, “Multi-Order Spectroscopy” filed on Nov. 17, 2022, which is incorporated herein by reference in its entirety.

### BACKGROUND

### 1. Technical Field

This disclosure relates generally to optical detection systems for spectroscopy and, more specifically, to optical detection systems for measuring diffraction orders from different optical beams.

### 2. Description of Related Art

A spectrometer is an instrument used to measure properties of light over a specific portion of the electromagnetic spectrum, typically used in spectroscopic analysis to identify materials. Spectrometers are used in many fields. For example, they are used in astronomy to analyze the radiation from objects and deduce their chemical composition.

### SUMMARY

Conventional spectrometers are configured to measure light from only a single optical beam, making it difficult to compare spectra from different optical beams, especially when comparison on small time scales is desired (e.g., on the order of microseconds) as synchronizing detectors at small time scales is difficult. The present disclosure overcomes the limitations of the prior art by providing optical detection systems configured to measure spectra from multiple optical beams at substantially the same time and using the same optical detector.

Some embodiments relate to a system including a diffraction grating, an optical detector, a first optical beam forming system, and a second optical beam forming system. The optical detector includes a detection surface that detects optical signals. The optical detector is positioned so the detection surface receives diffracted spectra from the diffraction grating. The first optical beam forming system directs a first optical beam towards the diffraction grating such that a diffracted spectrum of the first optical beam is received by a first portion of the detection surface of the optical detector. The second optical beam forming system directs a second optical beam towards the diffraction grating such that a diffracted spectrum of the second optical beam is received by a second portion of the detection surface of the optical detector.

Other aspects may include components, devices, systems, improvements, methods, processes, applications, computer readable mediums, and other technologies related to any of the above.

### BRIEF DESCRIPTION OF THE DRAWINGS

Embodiments of the disclosure have other advantages and features which will be more readily apparent from the following detailed description and the appended claims, when taken in conjunction with the examples in the accompanying drawings, in which:

FIGS. 1A and 1B are diagrams of an optical detection system, according to some embodiments.

FIG. 2 is a diagram of a reflective diffraction grating, according to some embodiments.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

### Optical Detection Systems

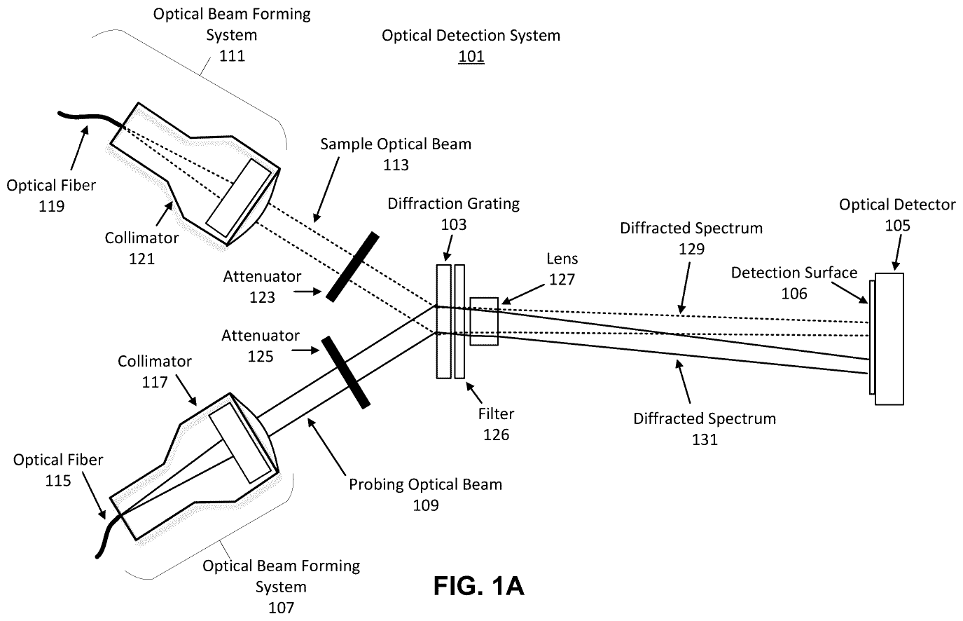

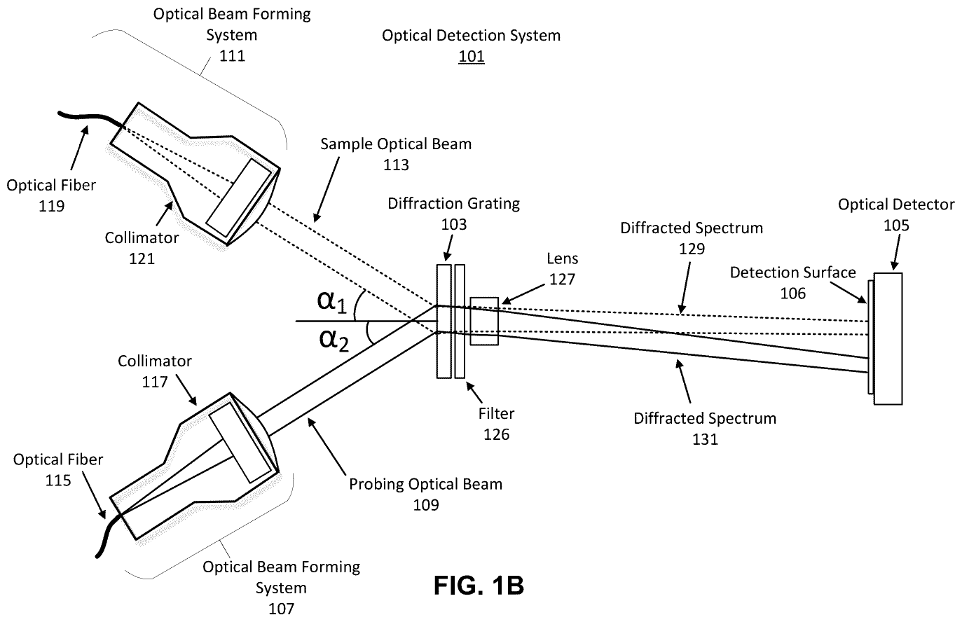

FIGS. 1A and 1B (collectively referred to as FIG. 1) are diagrams of an optical detection system 101, according to some embodiments. FIG. 1B is similar to FIG. 1A except the angles of incidence are labeled (α₁ and α₂) and the attenuators are not illustrated so that the angles of incidence can be seen. Other optical detection systems may include additional, fewer, or different components than those in FIG. 1 (e.g., another optical detection system does not include attenuators).

The optical detection system 101 includes a diffraction grating 103, an optical detector 105 with a detection surface 106, an optical beam forming system 107, and an optical beam forming system 111. The optical beam forming system 107 directs a probing optical beam 109 towards the diffraction grating 103, and the optical beam forming system 111 directs a sample optical beam 113 towards the diffraction grating 103. The optical beams are diffracted by the diffraction grating 103. The optical detector 105 is positioned to receive the diffracted spectra 129, 131 from the diffraction grating 103. More specifically, the optical beam forming system 107 directs the probing optical beam 109 towards the diffraction grating 103 at an angle of incidence α₂ so that a diffracted spectrum 131 (e.g., an order of diffraction or including an order of diffraction) of the probing optical beam 109 is received by a first portion (e.g., a bottom portion) of the detection surface 106. Similarly, the optical beam forming system 111 directs the sample optical beam 113 towards the diffraction grating 103 at an angle of incidence α₁ so that a diffracted spectrum 129 (e.g., an order of diffraction or including an order of diffraction) of the sample optical beam 113 is received by a second portion (e.g., a top portion) of the detection surface 106 (different than the first portion). The first and second portions of the detection surface 106 may be different (e.g., disjoint). For example, each spectrum is detected by a different set of pixels.

Among other advantages, the optical detection system 101 enables measurement of multiple spectral orders from multiple optical beams that pass through the same diffraction grating 103 and are detected by the same detector 105 at substantially the same time, thus enabling highly accurate comparisons of the diffracted spectra of the two beams.

The optical detection system 101 may be used in spectroscopy. For example, the probing optical beam 109 is a first portion of a source beam, and the sample optical beam 113 is a second portion of the source beam that was directed toward a spectroscopy sample. Interaction with the sample may change the spectrum of the second portion (e.g., the intensity of different wavelengths is modified). The resulting sample optical beam 113 is then directed toward the diffraction grating 103 by the optical beam forming system 111 so that the spectra 131, 129 of the two beams 109, 113 can be compared. For example, the diffracted spectrum 129 detected by the optical detector 105 may be normalized relative to the diffracted spectrum 131, thus enabling highly accurate observations of spectral changes produced by the spectroscopy sample interacting with the second portion of the optical beam. More specifically, since both beams pass through the same diffraction grating 103, defects in the optical detection system 101 (e.g., due to imperfections of the diffraction grating 103) may be negated. Furthermore, since the optical detector 105 detects both spectra at substantially the same time (not affected by the detector readout), time dependent non-uniformities in the source optical beam (e.g., peaks or dips in intensity) may also be negated since the non-uniformities will be present in both the probing and sample optical beams (assuming the beams are time synchronized with each other.

The above advantages of the optical detection system 101 for spectroscopy may be particularly useful for situations when the spectroscopy sample is expected to undergo a rapid change or to rapidly interact with the probing optical beam 109 (e.g., the sample is a fast-occurring chemical reaction (e.g., an explosion) or is a molecule rapidly transitioning to or from excited states). In these situations, it may be desirable to analyze spectra on small time scales e.g., time scales on the order of the detection rate of the optical detector 105 or on the order of microseconds. In another example, the optical detection system 101 may be useful in spectroscopy applications where it is desirable to capture (via the detector 105) a number of spectral samples (via images captured by the detector) per second in the range of fifty thousand to six hundred thousand spectral samples per second. More specifically, without system 101, one may need to use two separate spectrometers to measure two optical beams (since conventional spectrometers can only measure light from a single optical beam). However, it may be difficult to synchronize separate detectors of the spectrometers (especially at small time scales) and it may be difficult to account for optical defects unique to each of the spectrometers.

The optical detection system 101 may also be helpful to increase the detection resolution of an optical beam. For example, if the sample optical beam 113 and the probing optical beam 109 are different portions of a same source beam, then the diffracted spectra 129, 131 from the diffraction grating 103 are the same. Since the optical detector 105 detects the spectra on different portions of the detection surface 106, the detection signals can be analyzed to increase (e.g., double) the detection resolution of the source beam, potentially enabling resolution for previously unresolved features of the source beam.

Referring back to components in FIG. 1, the optical systems 107, 111 include optical components to direct the beams 109, 113 toward the diffraction grating 103 at the predetermined incidence angles α₁ and α₂. In the example of FIG. 1, the optical beam forming system 107 includes an optical fiber 115 carrying the probing optical beam 109 and a collimator 117. Similarly, the optical beam forming system 111 includes an optical fiber 119 and a collimator 121. The fibers may be gradient index fibers and the collimators may include one or more lenses (or other optical components) arranged to collimate the optical beams. Each of the optical beam forming systems may include additional, fewer, or different optical components than illustrated to direct the optical beams 109, 113 toward the diffraction grating 103 (e.g., each optical beam forming system has different optical components based on properties of the associated beams). For example, an optical beam forming system includes a waveguide instead of a fiber/collimator to direct a beam toward the diffraction grating 103. More generally, other optical components, such as metalized features, optical gratings, lenses, mirrors, prismatic structures, Fresnel structures, corner reflectors, retroreflectors, or some combination thereof may be included in a optical beam forming system so it directs a beam.

In the example of FIG. 1, the diffracted spectrum 129 is the +1 order of diffraction of the sample optical beam 113 and the diffracted spectrum 131 is the −1 order of diffraction of the probing optical beam 109 (the other orders are filtered out by filter 126). However, this is not required. Depending on the angles of incidence (α₁ and α₂) of the optical beams and the position of the optical detector 105, the optical detector 105 may receive other orders of diffraction for either of the optical beams. For example, the optical detector 105 receives the −2 and +2 orders of diffraction (or higher orders). Additionally, the magnitude of the orders of diffraction may be different (e.g., the −1 and +2 orders of diffraction). For example, it may be desirable for the detection surface 106 to receive the +1 and +2 orders of diffraction to measure one of the beams at a different (e.g., lower) spectral resolution or at a different wavelength range than the other beam. Furthermore, in the example of FIG. 1, the incidence angles α₁ and α₂ have equal magnitude but are in opposite directions (depending on the labeling convention, one angle may be positive and the other may be negative). However, this also is not required. If the angles have different magnitudes, this may result in the detection surface 106 receiving different orders of refraction.

The optical detector 105 includes a detection surface 106 of pixels or elements (e.g., an array of pixels) configured to measure light (e.g., received optical power). In some embodiments, the detection surface 106 includes a (e.g., linear) detector array or an image sensor.

In some embodiments, one of the beams (e.g., 109) may have a larger intensity that the other beam (e.g., 113), for example if the optical detection system 101 is used for spectroscopy as previously discussed. However, since practical detectors have a finite dynamic range, it may be beneficial for the spectra 129, 131 to be received with substantially equal intensity (e.g., having less than a threshold percent intensity difference (e.g., less than 2%-10%)) at the detector surface 106 (“dynamic range” refers to the ratio between the largest signal per pixel that can be measured and the typical noise that is present in the pixel's output). Additionally, or alternatively, it may be advantageous for the spectra to be received at (or within a threshold range of) a target intensity based on the detector type and wavelengths of the spectra (e.g., for typical camera noise value of 60 e⁻ (which refers to the electron readout noise), pixel size 12 microns, quantum efficiency of 40% and mid-range camera SNR of 30 dB, for 500 nm wavelength the incident light power density in the detection plane should be about 417 microW/m²). Reducing the intensity of one or more of the optical beams may be achieved using attenuators 123, 125 or an appropriate diffraction grating 103, as further discussed below.

The diffraction grating 103 is an optical grating with a periodic structure that diffracts light into several beams traveling in different directions. In the example of FIG. 1, the diffraction grating 103 is a transmissive diffraction grating. However, the diffraction grating 103 may alternatively be a reflective diffraction grating. In this case, the optical detector 105 in FIG. 1 may be reposited to receive the reflected diffraction orders. In some embodiments, the diffraction grating 103 is replaced with a prism (however, in these embodiments, additional optical components may be used to direct the desired spectra to detection surface 106).

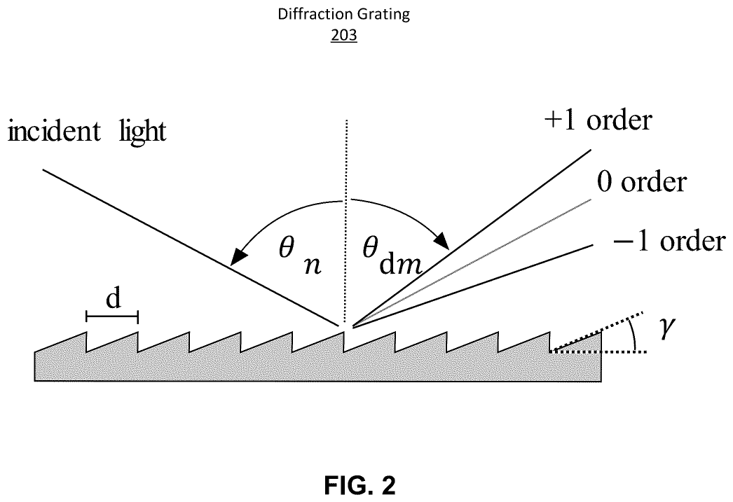

FIG. 2 is a diagram of an example diffraction grating 203 that may be used in an optical detection system, according to some embodiments. As illustrated, incident light (e.g., an optical beam) is diffracted into optical orders of m=+1, 0, and −1 (higher orders are not illustrated). d is the groove or facet spacing, γ is the blaze angle, θₙ is the angle of incidence, and θ_{dm} indicates the diffracted angles of the optical orders. The blaze angle is the angle between the surface structure and the surface parallel. Blazed design principles and geometry apply to both transmissive and reflective gratings. A diffraction grating (e.g., 103 or 203) may be designed to be efficient for a specific diffraction order (e.g., m=−1). This design may be optimal for a specific wavelength of the incident light, referred to as the blaze wavelength.

Changing γ makes it possible to manipulate the relative efficiencies of diffraction into orders (e.g., +1 and −1) as they are received by the optical detector 105. For example, if the +1 and −1 orders are of interest, the diffraction grating 103 may include a blaze angle that has a higher efficiency for those orders. A designer may further manipulate the efficiencies of diffraction into orders by designing a grating with different γ values. For example, a grating may have γ₁ for every other feature and γ₂≠γ₁ to the features in between. Other grating design parameters (e.g., groove shape, groove period, grating manufacturing modality (holographic vs. ruled) may additionally, or alternatively, be manipulated to achieve the desired spectra on the detection surface 106 depending on the set up of the optical detection system 101, the optical beams 109, 113, desired spectra 131, 129, etc.

As previously mentioned, in some embodiments, one of the beams (e.g., 109) may have a larger intensity than the other beam (e.g., 113). To reduce the difference in intensities received by the detector 105, the diffraction grating 103 may include a blaze angle γ which is more efficient for the lower intensity beam (e.g., 113). Said differently, a diffraction grating with a given blaze angle may be selected to reduce the intensity of one of the beams (e.g., 109). Other grating design parameters (e.g., groove shape, groove period, grating manufacturing modality (holographic vs. ruled) may additionally, or alternatively, be manipulated to achieve the desired the intensities on the detection surface 106. Additionally, or alternatively, optical attenuators 123, 125 may be adjusted to balance the two beam intensities, as further discussed below. However, in embodiments where the beams have substantially the same intensities, the diffraction grating 103 may include a blaze angle γ that is equally efficient for the beams.

Referring back to FIG. 1, the example spectroscopy system 101 includes additional optical components including (e.g., variable) attenuators 123, 125; a filter 126; and a lens 127. The lens 127 focuses the diffracted spectra toward the detection surface 106.

The attenuator 123 is along the optical path of the sample optical beam 113 between the optical beam forming system 111 and the diffraction grating 103 (said differently, the attenuators 123 is downstream the optical beam forming system 111 and upstream the diffraction grating 103). The attenuator 125 is similarly between the optical beam forming system 107 and the diffraction grating 103. Since the optical beams may have different intensities (depending on the embodiment), the attenuators may be used reduce the intensity of a beam to a desirable level. For example, the attenuators may be used to adjust the intensity of one or more beams so that the optical detector 105 receives diffraction orders of substantially the same intensity. Additionally, or alternatively, the attenuators may reduce the intensities of one or more beams as to fit their intensities within the dynamic range of the optical detector 105.

The filter 126 is an optical filter configured to selectively transmit specific wavelengths while attenuating or blocking other wavelengths. The filter 126 may be a spectral range bandpass filter. The filter 126 is selected to remove wavelengths outside of the spectral range of interest (e.g., wavelengths not included in the +1 and −1 diffraction orders). Among other advantages, the filter 126 prevents or reduces diffraction orders from interfering with each other. Furthermore, the filter prevents or reduces the detection surface 106 from receiving spectra (e.g., diffraction orders) outside the spectral range of interest.

In FIG. 1, the filter 126 is downstream the diffraction grating 103. In embodiments where the spectra have order numbers of different magnitudes (e.g., +1 and −2), the spectra may have different wavelengths. Thus, the filter 126 may be removed and the optical detection system 101 may include filters for each beam between the optical beam forming systems and the diffraction grating 103 (e.g., near the attenuators) so that each beam can be filtered appropriately (remove wavelengths outside of the range of interest for that beam).

As previously mentioned, optical detection systems may include additional, fewer, or different optical components than those in FIG. 1. For example, if the optical detector 105 is in a different position, the optical detection system 101 may include a first set of optical components (e.g., mirrors) to direct a diffracted spectrum (e.g., 129) toward the detection surface 106 and a second set of optical components to direct the other diffracted spectrum (e.g., 131) toward the detection surface 106.

Although the above embodiments are described in the context of optical detection systems with two optical beams (i.e., 109 and 113), optical detection systems may include additional beams with additional associated optical beam forming systems, attenuators, etc. that result in the additional beams having diffracted spectra incident on different portions of the detection surface 106.

Although the above embodiments were described in the context of the optical beam forming systems being adjacent to each other along an axis in the plane of the page of FIG. 1, other optical detection systems may have the optical beam forming systems in different locations. For example, the optical beam forming systems are adjacent to each other along an axis perpendicular to the page of FIG. 1 (said differently, into or out of the page). In this case, the diffracted spectra may still be incident on different portions of the detection surface 106 (e.g., portions along the axis perpendicular to the page of FIG. 1).

Additional embodiments and advantages of systems described herein are described below. These following descriptions may be new or repetitious of descriptions previously provided.

(1) In some embodiments, one of the optical beams (e.g., 113) includes an unknown spectrum (e.g., 129) to be measured and the other beam (e.g., 109) includes a known “reference” spectrum (e.g., 131). In these embodiments, collecting both spectra at substantially the same time, with well-matched dispersion and detection characteristics, makes it possible to compensate for non-ideal performance of a light source on a measurement-by-measurement basis (e.g., if the beams include time dependent non-uniformities) by, for example, dividing one measured spectra over the other one.

(2) In some embodiments, the two spectra 129, 131 can be detected sequentially at different times with a time resolution between the detections defined by the integration time of the detector 105 (e.g., in microseconds).

(3) Since both optical beams pass through the same diffraction grating 103 and are detected by the same detector 105, many of their detection characteristics are similar.

(4) The known correspondence of angles between diffraction orders and the fact that all signals pass through the same diffractive element (103) may guarantee matched dispersion between orders and beams.

### Configuration Overview

Some embodiments relate to a system (e.g., 101) including: a diffraction grating (e.g., 103); an optical detector (e.g., 105) including a detection surface (e.g., 106) configured to detect optical signals, the optical detector positioned so the detection surface receives diffracted spectra from the diffraction grating; a first optical beam forming system (e.g., 107) configured to direct a first optical beam (e.g., 109) towards the diffraction grating such that a diffracted spectrum (e.g., 131) of the first optical beam is received by a first portion of the detection surface of the optical detector; and a second optical beam forming system (e.g., 111) different that the first optical beam forming system, the second optical beam forming system configured to direct a second optical beam (e.g., 113) towards the diffraction grating such that a diffracted spectrum (e.g., 129) of the second optical beam is received by a second portion of the detection surface of the optical detector. In some embodiments, the first and second portions of the detection surface are disjoint.

In some embodiments, the optical detector simultaneously receives the diffracted spectrum of the first optical beam and the diffracted spectrum of the second optical beam. Due to this and since the spectra of the optical beams are incident on the same detection surface, the detector can detect both spectra at substantially the same time (e.g., (a) both are detected within with a single frame captured by the detector (the time to capture a frame may be based on the integration time or the exposure time of the detector) or (b) within a threshold time period (e.g., on the order of microseconds)).

In some embodiments, the first optical beam and the second optical beam are diffracted by the diffraction grating at the same time or at sequential moments of time (e.g., defined by the detector integration time and readout time).

In some embodiments, the diffracted spectrum of the first optical beam is a diffraction order of the first optical beam produced by the diffraction grating (e.g., the −1 order of diffraction); and the diffracted spectrum of the second optical beam is a diffraction order of the second optical beam produced by the diffraction grating (e.g., the +1 order of diffraction). In some embodiments, the system further includes an optical filter (e.g., 126) downstream from the diffraction grating, the optical filter configured to filter light so that the detection surface of the optical detector does not receive other diffraction orders produced by the diffraction grating (e.g., the detection surface 106 only receives the diffraction order of the first optical beam and the diffraction order of the second optical beam). In some embodiments, the diffraction order number of the first optical beam has the same magnitude as the diffraction order number of the second optical beam (e.g., one of the orders is −2 and the other is +2). In some embodiments, the diffraction order number of the first optical beam has the opposite sign as the diffraction order number of the second optical beam (e.g., one of the orders is −1 and the other is +1).

In some embodiments, the first optical beam is a first portion of a source beam, and the second optical beam is formed from a second portion of the source beam interacting with a spectroscopy sample (e.g., a beam splitter splits the source beam into the first and second portions).

In some embodiments, the first optical beam forming system is configured to direct the first optical beam towards the diffraction grating at an angle of incidence α₁; the second optical beam forming system is configured to direct the second optical beam towards the diffraction grating at an angle of incidence α₂. In some embodiments, the magnitudes of angles α₁ and α₂ are substantially equal (e.g., within a threshold difference of each other (e.g., within one or two degrees of each other)). The angles α₁ and α₂ may be based on spectral ranges, diffraction grating design parameters, spectra imaging optics focal length, and detector length such that spectra corresponding to each angle does not overlap at the detector. In some embodiments, the angles α₁ and α₂ are in opposite directions (e.g., α₁ and α₂ in FIG. 1B are in opposite directions of the surface normal in the plane of the page).

In some embodiments, the diffraction grating is a transmissive diffraction (e.g., see FIG. 1) grating or a reflective diffraction grating (e.g., FIG. 2).

In some embodiments, the system further includes: a first optical attenuator (e.g., 125) positioned to receive the first optical beam upstream of the diffraction grating and configured to reduce the intensity of the first optical beam; and a second optical attenuator (e.g., 123) positioned to receive the second optical beam upstream of the diffraction grating and configured to reduce the intensity of the second optical beam, where the first and second optical attenuators are configured such that the first and second portions of the detection surface receive substantially the same intensity (e.g., having less than a threshold percent intensity difference (e.g., less than 2%-10%)).

In some embodiments, a blaze angle of the diffraction grating is configured such that the first and second portions of the detection surface receive substantially the same intensity (e.g., having less than a threshold percent intensity difference (e.g., less than 2%-10%)).

In some embodiments, the techniques described herein relate to a system, wherein the second optical beam is the same beam as the first optical beam (e.g., the probing and second optical beams are different portions of a source beam (e.g., made using a beam splitter), and the system is used to increase the detection resolution of the source beam).

Other embodiments may include components, devices, systems, improvements, methods, processes, applications, computer readable mediums, and other technologies related to any of the above.

### ADDITIONAL CONSIDERATIONS

Although the detailed description contains many specifics, these should not be construed as limiting the scope of the invention but merely as illustrating different examples. It should be appreciated that the scope of the disclosure includes other embodiments not discussed in detail above. Various other modifications, changes and variations which will be apparent to those skilled in the art may be made in the arrangement, operation and details of the method and apparatus disclosed herein without departing from the spirit and scope as defined in the appended claims. Therefore, the scope of the invention should be determined by the appended claims and their legal equivalents.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise. Similarly, reference to an element in the singular is not intended to mean “one and only one” unless explicitly stated, but rather is meant to mean “one or more.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

What is claimed is:

1. A system comprising:
a diffraction grating;
an optical detector including a detection surface configured to detect optical signals, the optical detector positioned so the detection surface receives diffracted spectra from the diffraction grating;
a first optical beam forming system configured to direct a first optical beam towards the diffraction grating such that a diffracted spectrum of the first optical beam is received by a first portion of the detection surface of the optical detector; and
a second optical beam forming system different that the first optical beam forming system, the second optical beam forming system configured to direct a second optical beam towards the diffraction grating such that a diffracted spectrum of the second optical beam is received by a second portion of the detection surface of the optical detector.

2. The system of claim 1, wherein the optical detector simultaneously receives the diffracted spectrum of the first optical beam and the diffracted spectrum of the second optical beam.

3. The system of claim 1, wherein the first optical beam and the second optical beam are diffracted by the diffraction grating at the same time.

4. The system of claim 1, wherein:
the diffracted spectrum of the first optical beam is a diffraction order of the first optical beam produced by the diffraction grating; and
the diffracted spectrum of the second optical beam is a diffraction order of the second optical beam produced by the diffraction grating.

5. The system of claim 4, further comprising an optical filter downstream from the diffraction grating, the optical filter configured to filter light so that the detection surface of the optical detector does not receive other diffraction orders produced by the diffraction grating.

6. The system of claim 4, wherein the diffraction order number of the first optical beam has the same magnitude as the diffraction order number of the second optical beam.

7. The system of claim 6, wherein the diffraction order number of the first optical beam has the opposite sign as the diffraction order number of the second optical beam.

8. The system of claim 1, wherein the first optical beam is a first portion of a source beam, and the second optical beam is formed from a second portion of the source beam interacting with a spectroscopy sample.

9. The system of claim 1, wherein:
the first optical beam forming system is configured to direct the first optical beam towards the diffraction grating at an angle of incidence α₁;
the second optical beam forming system is configured to direct the second optical beam towards the diffraction grating at an angle of incidence α₂; and
the magnitudes of angles α₁ and α₂ are substantially equal.

10. The system of claim 9, wherein angles α₁ and α₂ are in opposite directions.

11. The system of claim 1, wherein the diffraction grating is a transmissive diffraction grating or a reflective diffraction grating.

12. The system of claim 1, further comprising:
a first optical attenuator positioned to receive the first optical beam upstream of the diffraction grating and configured to reduce the intensity of the first optical beam; and
a second optical attenuator positioned to receive the second optical beam upstream of the diffraction grating and configured to reduce the intensity of the second optical beam,
wherein the first and second optical attenuators are configured such that the first and second portions of the detection surface receive substantially the same intensity.

13. The system of claim 1, wherein a blaze angle of the diffraction grating is configured such that the first and second portions of the detection surface receive substantially the same intensity.

14. The system of claim 1, wherein the first and second portions of the detection surface are disjoint.

15. The system of claim 1, wherein the second optical beam is the same beam as the first optical beam.

16. A system comprising:
a means for diffracting light;
a means for detecting optical signals positioned to receive diffracted spectra from the means for diffracting light;
a means for directing a first optical beam towards the means for diffracting light such that a diffracted spectrum of the first optical beam is received by a first portion of the means for detecting optical signals; and
a means for directing a second optical beam towards the means for diffracting light such that a diffracted spectrum of the second optical beam is received by a second portion of the means for detecting optical signals.

17. The system of claim 16, wherein the means for detecting optical signals simultaneously receives the diffracted spectrum of the first optical beam and the diffracted spectrum of the second optical beam.

18. The system of claim 16, wherein the first optical beam and the second optical beam are diffracted by the means for diffracting light at the same time.

19. The system of claim 16, wherein:
the diffracted spectrum of the first optical beam is a diffraction order of the first optical beam produced by the means for diffracting light; and
the diffracted spectrum of the second optical beam is a diffraction order of the first optical beam produced by the means for diffracting light.

20. The system of claim 16, wherein the first optical beam is a first portion of a source beam, and the second optical beam is formed from a second portion of the source beam interacting with a spectroscopy sample.
